(19) United States
(12) Patent Application Publication
(10) Pub. No.: US 2011/0129703 A1
(43) Pub. Date: Jun. 2, 2011

(54) BATTERY PACK

(75) Inventor: Jung-Yup Han, Yongin-si (KR)

(73) Assignee: Samsung SDI Co., Ltd., Yongin-si (KR)

(21) Appl. No.: 12/901,264

(22) Filed: Oct. 8, 2010

(30) Foreign Application Priority Data
Nov. 30, 2009 (KR) 10-2009-0117089

(51) Int. Cl. H01M 2/12; H01M 2/02; H01M 10/50

(52) U.S. Cl. 429/82; 429/159; 429/120

(57) ABSTRACT

A battery pack including a hollow hexahedral casing includes a first panel having first supporting holes; and a second panel having second supporting holes formed at locations corresponding to locations of the first supporting holes; and includes a plurality of secondary batteries. First ends of the secondary batteries are supported by the first supporting holes and second ends of the secondary batteries are supported by the second supporting holes.

### CROSS-REFERENCE TO RELATED APPLICATION

This application claims the benefit of Korean Patent Application No. 10-2009-0117089, filed Nov. 30, 2009 in the Korean Intellectual Property Office, the disclosure of which is incorporated herein by reference.

### BACKGROUND

1. Field

One or more embodiments of the present invention relate to a battery pack, and more particularly, to a battery pack in which a plurality of secondary batteries are inserted into a hollow hexahedral casing for effective cooling of the secondary batteries and to securely hold the secondary batteries.

2. Description of the Related Art

A battery pack includes a plurality of secondary batteries and is installed in a device, such as an electric bike or a motorcycle. The temperature of the secondary batteries rises due to heat generated during operation of the battery pack. Thus, the lifespan thereof is shortened if heat is not effectively dissipated. Furthermore, it is necessary for a battery pack to firmly hold secondary batteries to prevent displacement of the secondary batteries from locations in which the secondary batteries were originally assembled. This is needed so that the secondary batteries are not detached due to shock or vibration while the device to which the battery pack is installed is running. Furthermore, when a battery pack is being fabricated by combining a plurality of secondary batteries, the secondary batteries should be electrically connected to each other before the secondary batteries are completely inserted into the battery pack. At this time, the secondary batteries may be moved or detached, and thus it is not easy to electrically connect the secondary batteries to each other.

### SUMMARY

One or more embodiments of the present invention include a battery pack in which secondary batteries are firmly held.

One or more embodiments of the present invention include a battery pack for effective cooling of secondary batteries.

One or more embodiments of the present invention include a battery pack to which secondary batteries may be electrically connected with ease.

According to one or more embodiments of the present invention, a battery pack includes a hollow hexahedral casing, which includes a first panel in which a plurality of first supporting holes are formed; and a second panel in which a plurality of second supporting holes are formed at locations corresponding to locations of the first supporting holes; and includes a plurality of secondary batteries, wherein first ends of the secondary batteries are supported by the first supporting holes and second ends of the secondary batteries are supported by the second supporting holes.

According to an aspect of the invention, each of the first panel and the second panel may further include one or more air ventilation holes.

According to an aspect of the invention, the first supporting holes and the second supporting holes may be arranged in a honeycomb-like shape.

According to an aspect of the invention, the casing may include an upper casing including the first panel and a lower casing including the second panel and attached to the upper casing.

According to an aspect of the invention, the casing may include side panels extending from edges of the first panel toward the second panel, and each of the side panels may include one or more side air ventilation holes.

According to an aspect of the invention, the casing may include cooling fins protruding outwardly from outer surfaces of the casing.

According to an aspect of the invention, the second panel may further include outer secondary battery supporting units that protrude from edges of the second supporting holes nearest to edges of the second panel to the centers of the outermost second supporting holes and that support the secondary batteries.

According to an aspect of the invention, the second panel may further include inner secondary battery supporting units that are attached to an outer surface of the second panel and extend into the centers of the second supporting holes that are not the second supporting holes nearest to edges of the second panel and that support the secondary batteries.

According to an aspect of the invention, the battery pack may further include a first connection tab for electrically connecting first end surfaces of the secondary batteries exposed outside of the casing by the first supporting holes and a second connection tab for electrically connecting second end surfaces of the secondary batteries exposed outside of the casing by the second supporting holes.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partially exploded perspective view of a casing of a battery pack according to an embodiment of the present invention;

FIG. 2 is a sectional view of a battery pack including the casing of FIG. 1;

FIG. 3 is a sectional view showing assembly of a battery pack according to another embodiment of the present invention; and

FIG. 4 is a sectional view of the battery pack after the assembly.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

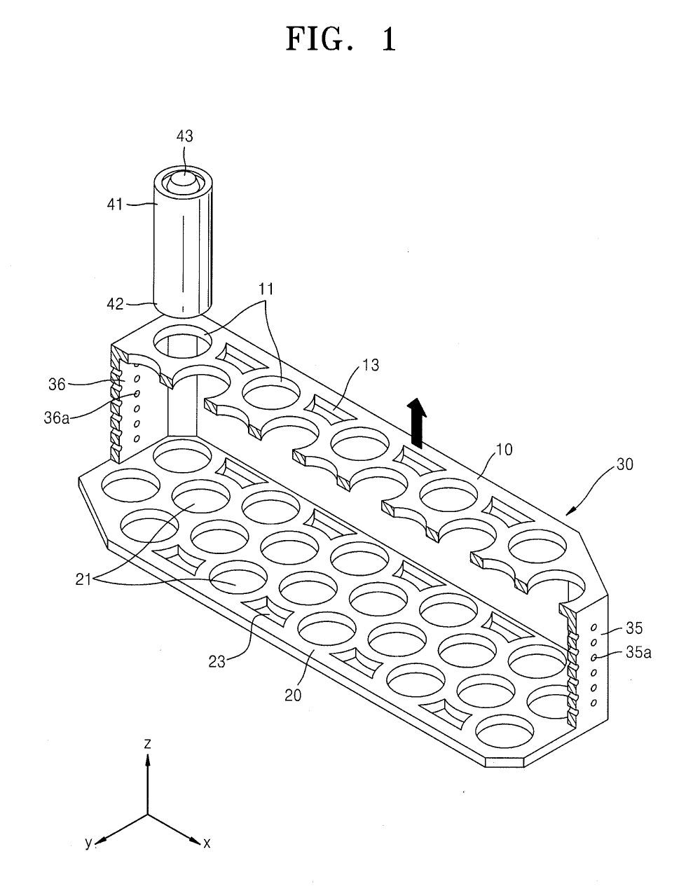

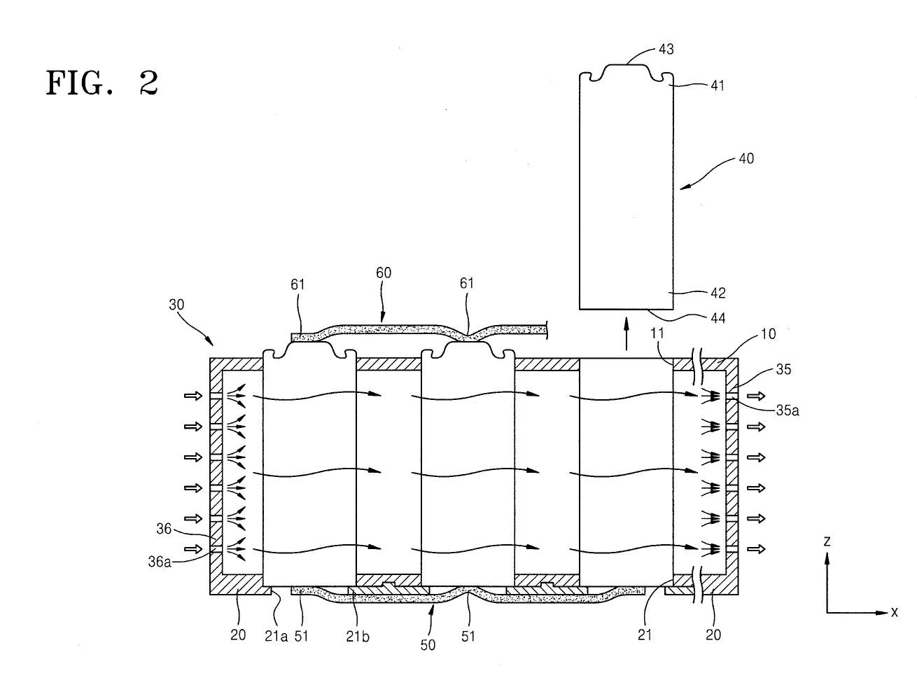

FIG. 1 is a partially exploded perspective view of a casing of a battery pack according to an embodiment of the present invention, and FIG. 2 is a sectional view of a battery pack including the casing of FIG. 1. In the battery pack, the battery pack includes a hollow hexahedral casing 30 and a plurality of secondary batteries 40 installed to the casing 30. The casing 30 is a hollow hexahedral structure including a first panel 10, a second panel 20, and side panels 35,36. The first panel 10 is shown in an upper portion of FIG. 1. The second panel 20 extends in correspondence to the first panel 10. The side panels 35 and 36 connect edges of the first panel 10 and the second panel 20. Since a space is formed within the casing 30, side surfaces of the secondary batteries 40 are exposed to outside air even after the secondary batteries 40 are inserted into the casing 30. Thus, the secondary batteries 40 may be effectively cooled. However, it is understood that, in other aspects, the sides do not both have to be open and that one or both of the sides can be closed using an additional panel or panels.

The first panel 10 of the casing 30 includes a plurality of first supporting holes 11. The second panel 20 of the casing 30 includes a plurality of second supporting holes 21 that are formed at locations corresponding to locations of the first supporting holes 11. The first supporting holes 11 and the second supporting holes 21 are formed in a honeycomb-like shape as shown in FIG. 1. While shown as round, it is understood that the shape of the supporting holes 11 and the second supporting holes 21 is not limited and can be any opening which is sized to support the corresponding secondary batteries 40. The first supporting holes 11 and the second supporting holes 21 are arrayed in rows which are diagonal to a length and width of the first and second panels 10, 20.

The first panel 10 includes air ventilation holes 13. The air ventilation holes 13 may be formed in regions that are formed between edges of the first panel 10 and the first supporting holes 11 when the first supporting holes 11 are formed in a honeycomb-like shape. The second panel 20 also includes air ventilation holes 23 that are formed similarly as described with respect to the air ventilation holes 13. The air ventilation holes 13 and 23 of the first and second panels 10 and 20 guide air within the casing 30 to be exhausted out of the casing 30, and thus air flows in the direction in which the secondary batteries 40 extend (the z axis direction in FIG. 1). As shown, the air ventilation holes 13 are arrayed in a width-wise column with the first supporting holes 11 such that the air ventilation holes 13 of adjacent columns of the first supporting holes 11 are disposed on opposite edges of the first panel 10.

The casing 30 may be formed of an insulating material which does not conduct electricity. An example of such a material is a plastic. Alternatively, the casing 30 may be formed by forming a metal frame, such as an aluminum frame, coated with an electrical insulation material on the frame.

Side air ventilation holes 35a and 36a connect the space in the casing 30 to the outside and are formed on the side panels 35 and 36 that extend from (the) edges of the first panel 10 of the casing 30 to the edges of the second panel 20 of the casing 30. The side air ventilation holes 35a and 36a introduce outside air into the casing 30 and exhaust air within the casing 30 out of the casing 30, so that air flows in a direction across the secondary batteries 40 (the x-axis direction from left to right in FIG. 2).

The secondary batteries 40 are battery assemblies that may be charged and discharged. First ends 41 of the secondary batteries 40 are supported by the first supporting holes 11, and second ends 42 of the secondary batteries 40 are supported by the second supporting holes 21. Each of the secondary batteries 40 includes a first end surface 43 as a top surface and a second end surface 44 as a bottom surface. The first end surfaces 43 are exposed outside of the casing 30 via the first supporting holes 11, whereas the second end surfaces 44 are exposed outside of the casing 30 via the second supporting holes 21. The first end surfaces 43 and the second end surfaces 44 may function as terminals for electric connection to external devices. As shown, the first end 41 protrudes through the hole 11, whereas the second end 42 rests on supporting units 21a and/or 21b within the hole 20.

A first connection tab 60 electrically connects the first end surfaces 43 of the secondary batteries 40, which are exposed outside of the casing 30 by the first supporting holes 11. The first connection tab 60 is arranged outside of the first panel 10 of the casing 30. The first connection tab 60 may be electrically connected to the secondary batteries 40 at groove portions 61, which are welded to the first end surfaces 43 as shown, but the invention is not limited thereto.

A second connection tab 50 electrically connects the second end surfaces 44 of the secondary batteries 40. The second end surfaces 44 are exposed outside of the casing 30 by the second supporting holes 21. The second connection tab 50 is arranged outside of the second panel 20 of the casing 30. The second connection tab 50 is also electrically connected to the secondary batteries 40 at groove portions 51, which are welded to the second end surfaces 44, but the invention is not limited thereto.

While not required in all aspects, the second panel 20 includes outer secondary battery supporting units 21a that protrude from edges of the second supporting holes 21 nearest to the edges of the second panel 20, that is, the outermost second supporting holes 21, to the centers of the outermost second supporting holes 21. The outer secondary battery supporting units 21a are portions extended from the second panel 20 and support the second end surfaces 44 of the secondary batteries 40. The secondary battery supporting units 21a can be formed integrally using a mold shaped to form a step at the secondary battery supporting units 21a or by forming a hole having an initial diameter and forming a step by milling away material above the secondary battery supporting units 21a to form the remainder of the second supporting holes 21. While show as integral to the second panel 20, the supports 21a can be formed using inserts, clips, etc.

The second panel 20 includes inner secondary battery supporting units 21b that are attached to an outer surface of the second panel 20 and extend from edges of the second supporting holes 21 into centers of the second supporting holes 21. Where the second supporting holes 21 are the outermost second supporting holes 21, the inner secondary battery supporting units 21b extend from an edge of the second supporting holes 21 opposite to the outer secondary battery supporting units 21a. The inner secondary battery supporting units 21b may be formed separate from the second panel 20 and attached to the second panel 20 to support the second end surfaces 44 of the secondary batteries 40. However, it is understood that the units 21b can be formed integral with the panel, such as where the units 21a, 21b comprise a single groove around an inner periphery of the holes 20.

During assembly of a battery pack, the outer secondary battery supporting units 21a and the inner secondary battery supporting units 21b may firmly hold the secondary batteries 40 when the secondary batteries 40 are inserted into the first supporting holes 11 and the second supporting holes 21 of the casing 30. Therefore, welding of the first connection tab 60 and the second connection tab 50 to the secondary batteries 40 may be stably performed, and the connection between the secondary batteries 40 and the casing 30 may be maintained firm while the battery pack is being used.

In a battery pack as described above, air outside the casing 30 is introduced into the casing 30 via the air ventilation holes 13, 23, 35a, and 36a, and the side surfaces of the secondary batteries 40 attached to the casing 30 are exposed to air. Therefore, the secondary batteries 40 may be effectively cooled.

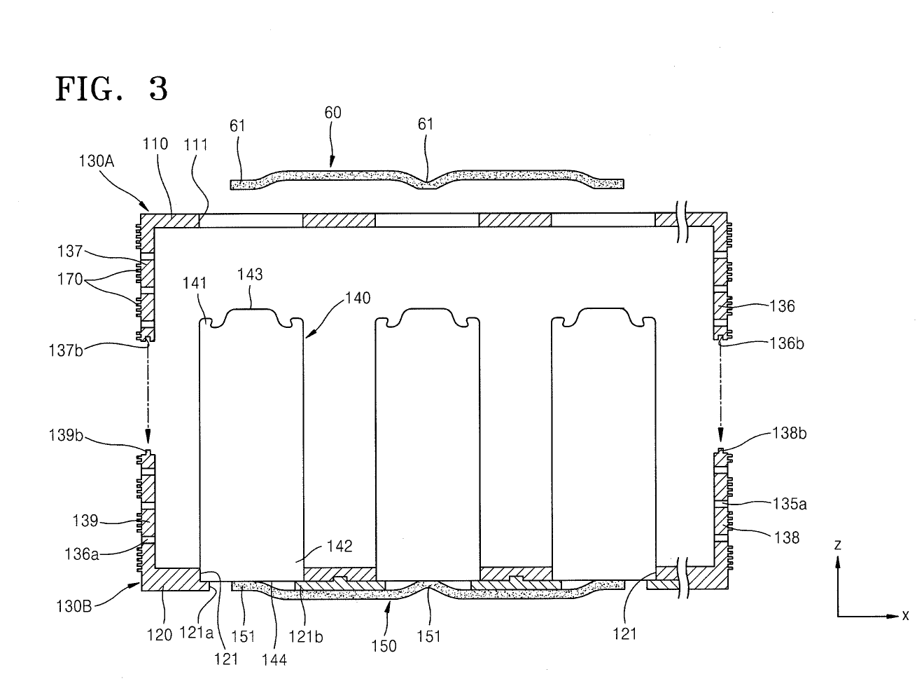

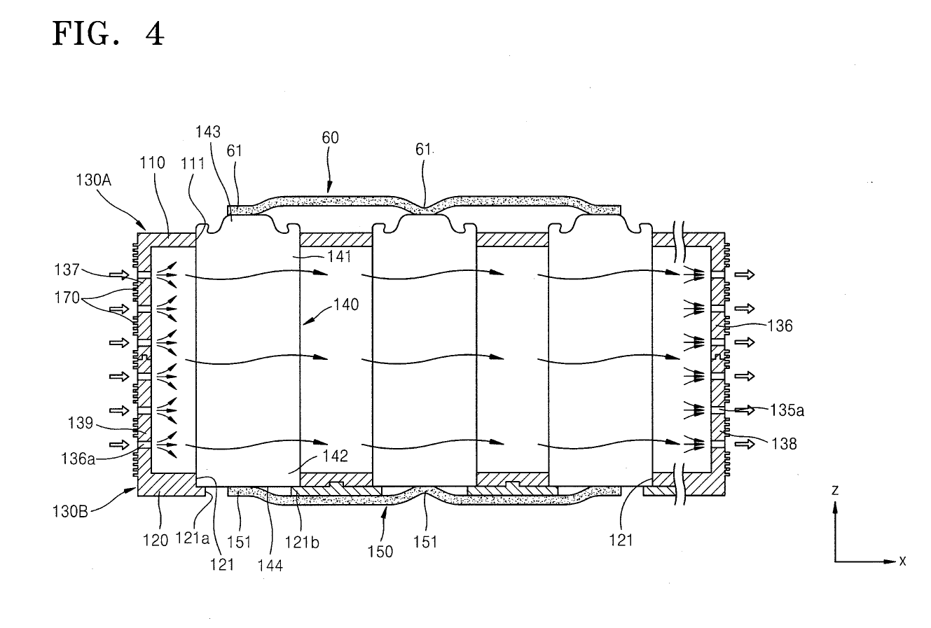

FIG. 3 is a sectional view showing assembly of a battery pack according to another embodiment of the present invention, and FIG. 4 is a sectional view of the battery pack after the assembly. The battery pack includes a hollow hexahedral casing 130A and 130B and a plurality of secondary batteries 140 installed to the casing 130A and 130B.

Although the casing 30 is fabricated as a single hollow hexahedral structure in the embodiment shown in FIG. 1, the embodiment shown in FIGS. 3 and 4 provides an upper casing 130A including the first panel 110 and a lower casing 130B including the second panel 120. The upper casing 130A includes side panels 136 and 137 extending from the first panel 110 toward the lower casing 130B. Grooves 136b and 137b are formed on bottom surfaces of the side panels 136 and 137 of the upper casing 130A.

The lower casing 130B includes side panels 138 and 139 extending from the second panel 120 toward the upper casing 130A. Protrusions 138b and 139b having shapes corresponding to the grooves 136b and 137b are formed on top surfaces of the side panels 138 and 139 of the lower casing 130B. The upper casing 130A and the lower casing 130B may be combined to form a hollow hexahedral structure when the protrusions 138b and 139b are inserted into the grooves 136b and 137b.

Since a space is formed inside the casings 130A and 130B when the upper casing 130A and the lower casing 130B are combined, side surfaces of the secondary batteries 140 are exposed to air even after the secondary batteries 140 are inserted into the combined casings 130A and 130B, and thus the secondary batteries 140 may be effectively cooled.

The first panel 110 of the upper casing 130A includes a plurality of first supporting holes 111. The second panel 120 of the lower casing 130B includes a plurality of second supporting holes 121 that are formed at locations corresponding to locations of the first supporting holes 111. The first supporting holes 111 and the second supporting holes 121 are formed in a honeycomb-like shape, such as in the embodiment shown in FIG. 1.

The upper casing 130A and the lower casing 130B may be formed of an insulating material which does not conduct electricity (e.g., a plastic). Alternatively, the upper casing 130A and the lower casing 130B may be formed by forming a metal frame, such as an aluminum frame, coated with an electrical insulation material on the frame.

Side air ventilation holes 135a and 136a connect the inner space formed when the upper casing 130A and the lower casing 130B are combined to the outside, may be formed on the side panels 136, 137, 138, and 139 of the upper casing 130A and the lower casing 130B. The side air ventilation holes 135a and 136a introduces outside air into the combined casings 130A and 130B and exhausts air within the combined casings 130A and 130B out of the combined casings 130a and 130B, so that air flows in a direction across the secondary batteries 140 (the x-axis direction from left to right in FIG. 4).

The secondary batteries 140 are battery assemblies that may be charged and discharged. First ends 141 of the secondary batteries 140 are supported by the first supporting holes 111, and second ends of 142 the secondary batteries 140 are supported by the second supporting holes 121. Each of the secondary batteries 140 includes a first end surface 143 as a top surface and a second end surface 144 as a bottom surface. The first end surfaces 143 are exposed outside of the upper casing 130A via the first supporting holes 111, whereas the second end surfaces 144 are exposed outside of the lower casing 130B via the second supporting holes 121. The first end surfaces 143 and the second end surfaces 144 may function as terminals for electric connection to external devices.

A first connection tab 60 electrically connects the first end surfaces 143 of the secondary batteries 140 exposed outside of the upper casing 130A by the first supporting holes 111. The first connection tab 60 is arranged outside the first panel 110 of the upper casing 130A. The shown first connection tab 60 is electrically connected to the secondary batteries 140 at groove portions 61 which are welded to the first end surfaces 143.

A second connection tab 150 electrically connects the second end surfaces 144 of the secondary batteries 140 exposed outside of the lower casing 130B by the second supporting holes 121. The second connection tab 50 is arranged outside the second panel 120 of the lower casing 130B. The second connection tab 50 is also electrically connected to the secondary batteries 140 at groove portions 151 which are welded to the second end surfaces 144.

The second panel 120 includes outer secondary battery supporting units 121a that protrude from edges of the second supporting holes 121 nearest to edges of the second panel 120, that is, the outermost second supporting holes 121, to the center of the outermost second supporting holes 121. The outer secondary battery supporting units 121a are portions extended from the second panel 120 and support the second end surfaces 144 of the secondary batteries 140.

The second panel 120 includes inner secondary battery supporting units 121b that are attached to an outer surface of the second panel 120 and extend into the centers of the second supporting holes 121 from edges of the second supporting holes 121. Where the second supporting holes 121 are the outermost second supporting holes 121, the inner secondary battery supporting units 121b extend from an edge of the outermost second supporting holes 121 which is opposite to the edge having the outer secondary battery supporting units 121a. The inner secondary battery supporting units 121b may be formed separate from the second panel 120 and attached to the second panel 120 to support the second end surfaces 144 of the secondary batteries 140.

During assembly of a battery pack, the outer secondary battery supporting units 121a and the inner secondary battery supporting units 121b firmly hold the secondary batteries 140 when the secondary batteries 140 are inserted into the first supporting holes 111 and the second supporting holes 121 of the combined casings 130A and 130B. Therefore, welding of the first connection tab 60 and the second connection tab 150 to the secondary batteries 140 may be stably performed, and the connection between the secondary batteries 140 and the combined casing 130A and 130B may be maintained firm while the battery pack is being used.

While not required in all aspects, the combined casings 130A and 130B further include cooling fins 170 that protrude outwardly from outer surfaces of the combined casings 130A and 130B. The cooling fins 170 radiate heat from the combined casing 130A and 130B. However, it is understood that the cooling fins 170 need not be used in all aspects.

In a battery pack as described above, air outside the combined casings 130A and 130B is introduced into the combined casing 130A and 130B via the air ventilation holes 135a and 136a, and the side surfaces of the secondary batteries 140 attached to the combined casings 130A and 130B are exposed to outside air. Therefore, the secondary batteries 140 may be effectively cooled.

As described above, according to the one or more of the above embodiments of the present invention, secondary batteries are inserted into a hollow hexahedral casing. The secondary batteries may be effectively cooled by air contacting side surfaces of the secondary batteries. Furthermore, since the secondary batteries are firmly held by the casing, a battery pack may be easily assembled, and the attachment of the secondary batteries to the casing may be securely held. While not restricted thereto, such a battery pack can be useable in mobile devices, such as an electric bike, a motorcycle, a car, an aircraft or on personal devices which are subject to shock.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A battery pack comprising:
a hollow hexahedral casing comprising:
a first panel having first supporting holes; and
a second panel having second supporting holes formed at locations corresponding to locations of the first supporting holes; and
a plurality of secondary batteries, wherein a first end of each of the secondary batteries is supported by a corresponding one of the first supporting holes and a second end of each of the secondary batteries is supported by a corresponding one of the second supporting holes.

2. The battery pack of claim 1, wherein each of the first panel and the second panel further comprises one or more air ventilation holes.

3. The battery pack of claim 1, wherein the first supporting holes and the second supporting holes are arranged in a honeycomb-like shape.

4. The battery pack of claim 1, wherein the casing comprises an upper casing including the first panel and a lower casing including the second panel and which is attached to the upper casing.

5. The battery pack of claim 1, wherein the casing comprises further comprises side panels extending from edges of the first panel toward edges of the second panel, and
each of the side panels comprises one or more side air ventilation holes.

6. The battery pack of claim 1, wherein the casing further comprises cooling fins protruding outwardly from outer surfaces of the casing.

7. The battery pack of claim 1, wherein the second panel further comprises outer secondary battery supporting units that support the secondary batteries, wherein each of the outer secondary battery supporting units protrudes from an edge of a corresponding one of the second supporting holes nearest to edges of the second panel towards a center of the corresponding one second supporting hole.

8. The battery pack of claim 1, wherein the second panel further comprises inner secondary battery supporting units that are attached to an outer surface of the second panel and that support the secondary batteries, wherein each of the inner secondary battery supporting units extends into a center of a corresponding one of the second supporting holes that is not one the second supporting holes nearest to edges of the second panel.

9. The battery pack of claim 1, further comprising a first connection tab which electrically connects the first end surfaces of the secondary batteries exposed outside of the casing by the first supporting holes and a second connection tab which electrically connects the second end surfaces of the secondary batteries exposed outside of the casing by the second supporting holes.

10. A casing for a battery pack having battery cells, the casing comprising:
a first panel having first supporting openings, each first supporting opening being sized to support a first end of a corresponding one of the battery cells;
a second panel having second supporting openings disposed opposite the first supporting openings, each second supporting opening being sized to support a second end of a corresponding one of the battery cells so as to firmly hold the battery cells within the casing; and
side panels extending between and connecting the first and second panels.

11. The casing of claim 10, wherein each of the first panel, the second panel, and the side panel further comprises air ventilation holes separate from the first and second supporting openings.

12. The casing of claim 10, wherein each of the side panels comprises:
a first side portion extending from an edge of the first panel and having a groove, and
a second side portion extending from an edge of the second panel and having a protrusion which fits into the groove.

13. The casing of claim 10, further comprising cooling fins protruding outwardly from outer surfaces of the casing.

14. The casing of claim 10, wherein:
each of the first supporting openings is sized so as to allow the corresponding one of the battery cells to be inserted through the first supporting opening to be supported by a corresponding one of the second supporting openings; and
each of the second supporting openings further comprises an edge which reduces a size of the second supporting opening to prevent the corresponding inserted battery cell from passing through the second supporting opening.

15. The casing of claim 10, wherein each of the second supporting openings further comprises an edge which reduces a size of the second supporting opening to prevent the corresponding battery cell from passing through the second supporting opening.

16. The casing of claim 15, further comprising battery supporting units connected to the second panel and extending into corresponding second supporting openings to form the edges within the second supporting openings.

17. The casing of claim 10, wherein the first supporting openings are arranged in rows which are at an angle to a length and a width of the first panel.

18. The casing of claim 17, wherein the first supporting openings are arranged in columns which are parallel to a width of the first panel, and each column contains an air ventilation hole.

19. The casing of claim 18, wherein the air ventilation holes of adjacent columns are disposed on opposite edges of the first panel.

20. The casing of claim 10, wherein:
each first supporting opening is sized to allow a first tab to electrically interconnect, from an exterior of the casing, the first end of the corresponding one of the battery cells and an adjacent one of the battery cells, and
each second supporting opening is sized to allow a second tab to electrically interconnect, from the exterior of the casing, the second end of the corresponding one of the battery cells and an adjacent one of the battery cells.
